(19) United States
(12) Patent Application Publication
(10) Pub. No.: US 2012/0259914 A1
(43) Pub. Date: Oct. 11, 2012

(54) SERVER, CLIENT TERMINAL, AND INFORMATION PROCESSING METHOD

(75) Inventors: Kazuaki ANDO, Shibuya (JP); Hiroyuki Seki, Yokohama (JP)

(73) Assignee: FUJITSU LIMITED, Kawasaki-shi (JP)

(21) Appl. No.: 13/439,139

(22) Filed: Apr. 4, 2012

(30) Foreign Application Priority Data
Apr. 8, 2011 (JP) 2011-086518

(51) Int. Cl. G06F 15/16

(52) U.S. Cl. 709/203

(57) ABSTRACT

A server includes a receiver receiving the input information, location information, and route information of a client terminal; a processor processing a file based on the input information and predicting the quality of a radio communication with the client terminal on the route indicated by the route information based on the location information and stored communications quality information; and a transmitter transmitting an image to be displayed to the client terminal based on the result of processing the file. The processor transmits first data, which are at least part of the file, to the client terminal if an interruption of the radio communication is predicted. The processor receives second data, which are the first data processed by the client terminal during the interruption of the radio communication, from the client terminal after the radio communication is restored, and replaces the first data with the received second data.

### CROSS-REFERENCE TO RELATED APPLICATION

This application is based upon and claims the benefit of priority of the prior Japanese Patent Application No. 2011-086518, filed on Apr. 8, 2011, the entire contents of which are incorporated herein by reference.

### FIELD

A certain aspect of the embodiments discussed herein is related to a system including client terminals and a server.

### BACKGROUND

In these years, in order to improve security such as prevention of information leakage, thin client systems have been widely used that include a server and multiple client terminals that are interconnected via a network. Typical systems for implementing thin client systems are the network boot system and the server based system.

According to the network boot system, an operating system (OS) image is provided on the server side, and a client terminal downloads and boots the OS on the server via a network. According to this system, the client terminal has an application program, and activates and executes the application program after booting the OS. The client terminal transfers the data of a file processed by the executed application to the server via the network according to a common file transfer method. The network boot system has an advantage in application compatibility because the processing of an application is executed on the client terminal side. On the other hand, the network boot system has disadvantages in terms of network loads and information leakage on the network because an OS image and file data are transferred over the network.

According to the server based system, a server performs all processing such as execution of an application. According to this system, a client terminal transmits, to the server, information input to the client terminal through various input devices (such as a keyboard and a mouse) connected to the client terminal. The server processes a file on an application based on the received input information, and transmits screen information (an image) as the result of the processing to the client terminal. That is, according to this system, the client terminal serves only as a remote operation terminal. According to this system, the amount of data transferred over the network is reduced compared with the network boot system. Therefore, the server based system has advantages over the network boot system in terms of network loads and information leakage on the network.

It is known to construct a thin client system by connecting a server and client terminals via a radio network.

For related art, reference may be made to Japanese Laid-open Patent Publication No. 2009-246758.

### SUMMARY

According to an aspect of the invention, a server includes a storage configured to store communications quality information including communications quality of predetermined geographical areas on an area basis; a receiver configured to receive information input to a client terminal, location information of the client terminal, and route information of the client terminal from the client terminal via a radio communication; a processor configured to process a file based on the input information, and to predict quality of the radio communication with the client terminal on a route indicated by the route information of the client terminal based on the location information of the client terminal and the communications quality information; and a transmitter configured to transmit an image to be displayed on the client terminal to the client terminal via the radio communication based on a result of processing the file by the processor, wherein the processor is configured to transmit first data to the client terminal if an interruption of the radio communication with the client terminal is predicted, the first data being at least a part of the file, and to receive second data from the client terminal after the radio communication with the client terminal is restored and to replace the first data with the received second data, the second data being the first data processed by the client terminal during the interruption of the radio communication.

According to an aspect of the invention, a client terminal includes a receiver configured to receive first data from a server, the first data being at least a part of a file stored in the server; a file processor configured to process the first data during an interruption of a radio communication with the server; and a transmitter configured to transmit second data to the server after the radio communication with the server is restored, the second data being the first data processed by the file processor during the interruption of the radio communication, wherein the file processor is configured to delete at least one of the first data and the second data from the client terminal after the radio communication with the server is restored.

According to an aspect of the invention, an information processing method includes transmitting, by a client terminal, information input to the client terminal, location information of the client terminal, and route information of the client terminal to a server via a radio communication; processing, by the server, a file based on the input information, and transmitting, by the server, an image to be displayed on the client terminal to the client terminal via the radio communication based on a result of said processing; referring to, by the server, communications quality information including communications quality of predetermined geographical areas on an area basis, and predicting, by the server, quality of the radio communication with the client terminal on a route indicated by the route information of the client terminal based on the location information of the client terminal and the communications quality information; transmitting, by the server, first data to the client terminal if an interruption of the radio communication with the client terminal is predicted, the first data being at least a part of the file; transmitting, by the client terminal, second data to the server after the radio communication with the server is restored, the second data being the first data processed by the client terminal during the interruption of the radio communication; and replacing, by the server, the first data with the second data received from the client terminal.

The object and advantages of the embodiments will be realized and attained by means of the elements and combinations particularly pointed out in the claims.

It is to be understood that both the foregoing general description and the following detailed description are exemplary and explanatory and not restrictive of the invention, as claimed.

### BRIEF DESCRIPTION OF THE DRAWINGS

FIG. 1 is a schematic diagram illustrating a configuration of a thin client system according to a first embodiment;

FIG. 2 is a block diagram illustrating a hardware configuration of a client terminal and a hardware configuration of a server according to the first embodiment;

FIG. 3 is a functional block diagram illustrating functions of the client terminal according to the first embodiment;

FIG. 4 is a diagram illustrating data stored in the client terminal according to the first embodiment;

FIG. 5 is a functional block diagram illustrating functions of the server according to the first embodiment;

FIG. 6 is a diagram illustrating data stored in the server according to the first embodiment;

FIG. 7 is a diagram conceptually illustrating communications quality information retained by the server according to the first embodiment;

FIG. 8 is a diagram conceptually illustrating a correlation between the route of the client terminal and the communications quality information retained by the server according to the first embodiment;

FIG. 9 is a flowchart illustrating an overall process flow of the client terminal and the server in the thin client system according to the first embodiment;

FIG. 10 is a flowchart illustrating a process at a time when the communications between the client terminal and the server are interrupted in the thin client system according to the first embodiment;

FIG. 11 is a functional block diagram illustrating functions of the server according to a second embodiment;

FIGS. 12A and 12B are diagrams illustrating examples of a file and data of the file to be transmitted to the client terminal by the server according to the second embodiment;

FIGS. 13A and 13B are diagrams illustrating examples of the file and the data of the file to be transmitted to the client terminal by the server according to the second embodiment; and

FIG. 14 is a flowchart illustrating a process at a time when the communications between the client terminal and the server are interrupted in the thin client system according to the second embodiment.

### DESCRIPTION OF EMBODIMENTS

The above-described thin client system according to the server based system is advantageous in terms of network loads and information leakage on the network. However, if the system is constructed using a radio network, it is difficult to perform communications between a server and a client terminal where the quality of radio communications degrades. Therefore, it is difficult to continue processing a file where the quality of radio communications degrades. Accordingly, in the case of constructing a thin client system using a radio network, it is desired to take some measure to enable continuation of file processing irrespective of the quality of radio communications.

According to an aspect of the invention, a server and an information processing method are provided that enable continuation of file processing irrespective of the presence or absence of an interruption of communications between a client terminal and the server in a thin client system where a file is processed using a radio network.

According to an aspect of the invention, it is possible to continue processing a file irrespective of the presence or absence of an interruption of communications between a client terminal and a server in a system where the file is processed using a radio network.

Preferred embodiments of the present invention will be explained with reference to accompanying drawings.

### [a] First Embodiment

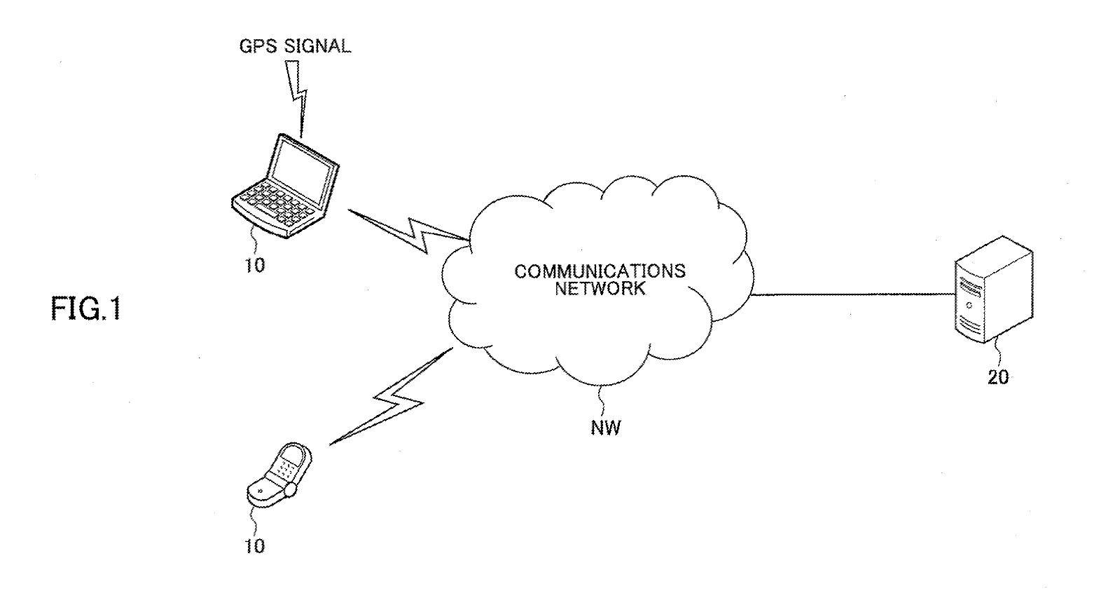

FIG. 1 is a schematic diagram illustrating a configuration of a thin client system according to a first embodiment. The thin client system illustrated in FIG. 1 is preferably based on the server based system. The thin client system includes multiple client terminals 10 and a server 20, which are connected via a communications network NW including a radio access network, the Internet, etc., so that the client terminals 10 and the server 20 may communicate with each other.

The client terminals 10 are, for example, portable terminals operated by moving users, such as cellular phones, personal digital assistant (PDA)s, and laptop personal computers. As illustrated in FIG. 1, the client terminals 10 receive global positioning system (GPS) signals from GPS satellites, and obtain information on their respective locations (location information) based on the GPS signals. The server 20 provides the client terminals 10 with thin client services.

In the following description, the server 20's service of processing a particular file by executing an application program (executing an application) is assumed to be the thin client service provided to the client terminals 10 by the server 20. Further, the client terminals 10 may be collectively referred to as the client terminal 10 where the description may be common to the multiple client terminals 10.

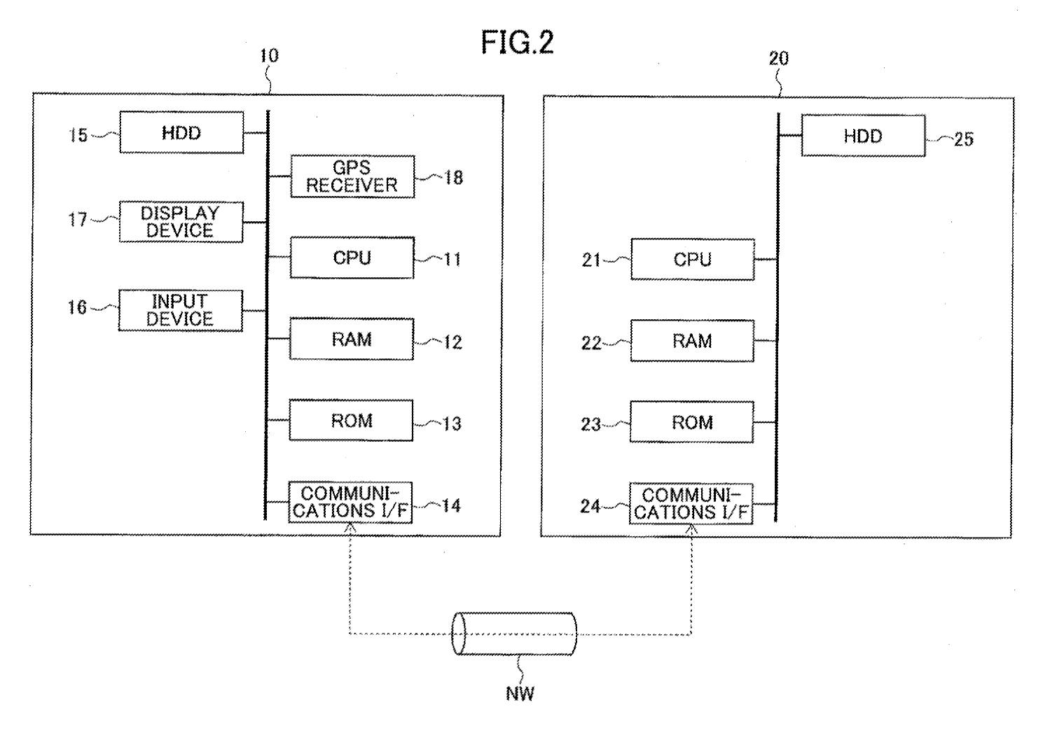

Next, a description is given, with reference to FIG. 2, of a hardware configuration of the client terminal 10 and a hardware configuration of the server 20. FIG. 2 is a block diagram illustrating a hardware configuration of the client terminal 10 and a hardware configuration of the server 20.

Referring to FIG. 2, the client terminal 10 includes a central processing unit (CPU) 11, a random access memory (RAM) 12, a read-only memory (ROM) 13, a communications interface (I/F) 14, a hard disk drive (HDD) 15, an input device 16, a display device 17, and a GPS receiver 18, which are interconnected by a control bus and/or a data bus.

The CPU 11 performs input/output control, signal processing, and control of components inside the client terminal 10. Upon activation of the client terminal 10, the CPU 11 loads an operating system (OS) and various programs contained (stored) in the ROM 13 into the RAM 12, and executes the loaded OS and programs. The RAM 12 is the main memory (primary storage) of the CPU 11. The RAM 12 is a volatile storage for temporarily storing programs executed by the CPU 11 and data referred to by the CPU 11.

The communications interface 14 performs processing (including, for example, orthogonal transformation, modulation and demodulation, and coding and decoding) on radio signals transmitted and received via the communications network NW, and performs communications protocol-related processing for communications with the server 20. The HDD 15 is a nonvolatile storage for storing data.

Devices that receive a user's input operations, such as a keyboard and a mouse, are collectively referred to as the input device 16. The input device 16 generates input information according to the user's input operations, and transmits the generated input information to the CPU 11. The display device 17 includes a display panel such as a liquid crystal display (LCD) and a display driver circuit, and displays an image on the display panel based on image data provided by the CPU 11.

The GPS receiver 18 receives GPS signals from GPS satellites, and calculates the location (position) information of the client terminal 10 based on the received GPS signals.

Referring to FIG. 2, the server 20 includes a CPU 21, a RAM 22, a ROM 23, a communications interface (I/F) 24, and an HDD 25, which are interconnected by a control bus and/or a data bus.

The CPU 21 performs input/output control, signal processing, and control of components inside the server 20. Upon activation of the server 20, the CPU 21 loads an operating system (OS) and various programs contained (stored) in the ROM 23 into the RAM 22, and executes the loaded OS and programs. The RAM 22 is the main memory (primary storage) of the CPU 21. The RAM 22 is a volatile storage for temporarily storing programs executed by the CPU 21 and data referred to by the CPU 21.

The communications interface 24 performs processing (including, for example, orthogonal transformation, modulation and demodulation, and coding and decoding) on radio signals transmitted and received via the communications network NW, and performs communications protocol-related processing for communications with the client terminal 10. The HDD 25 is a nonvolatile storage for storing data.

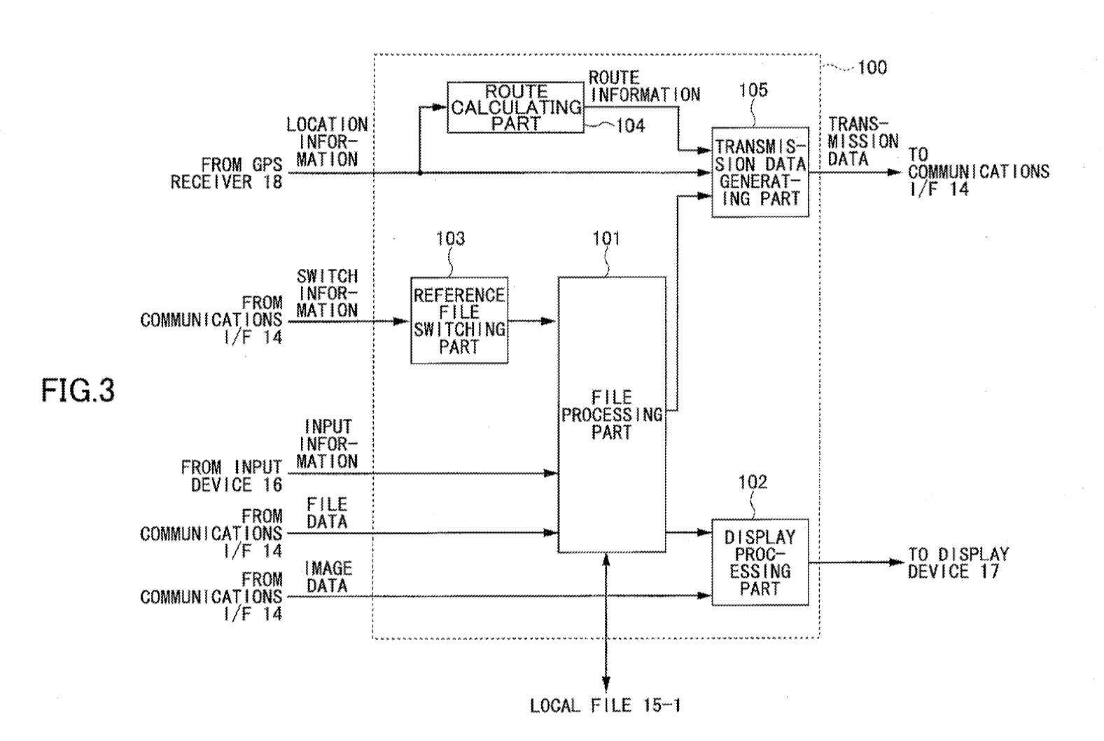

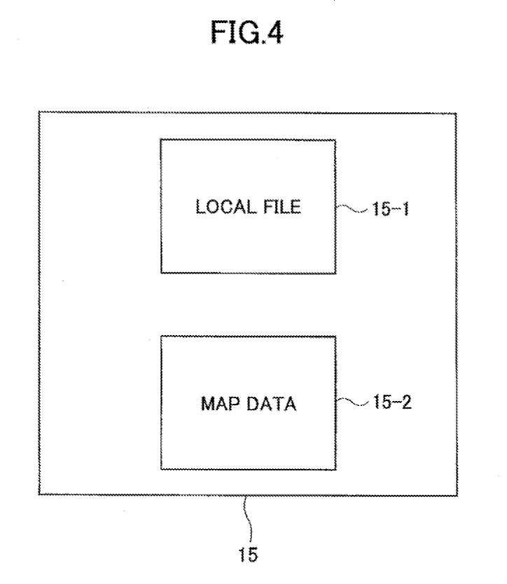

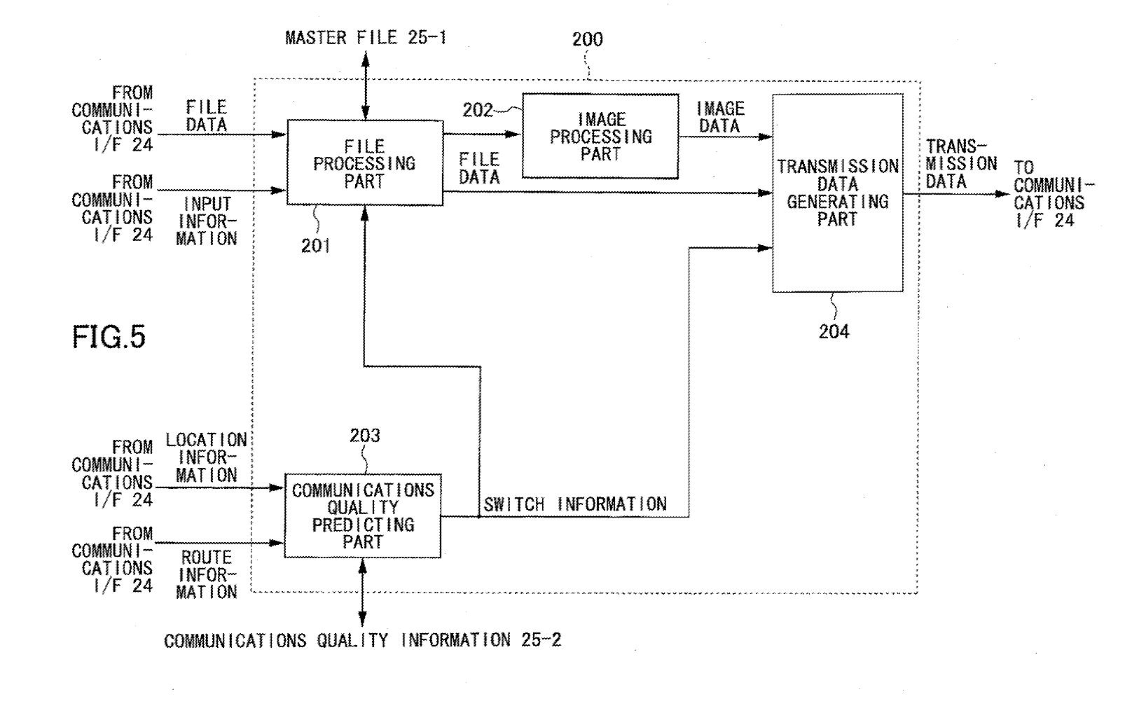

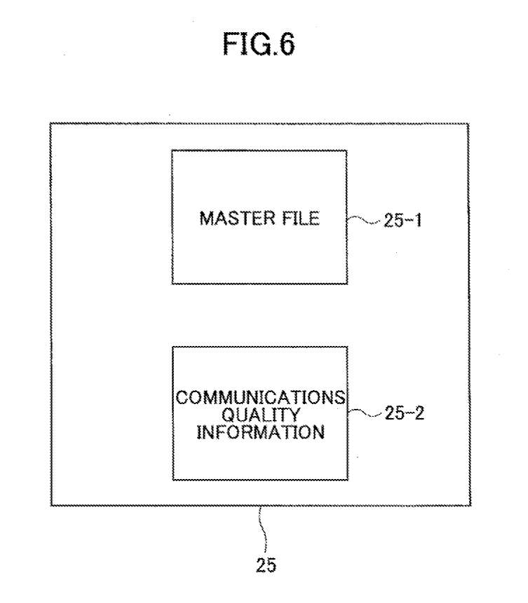

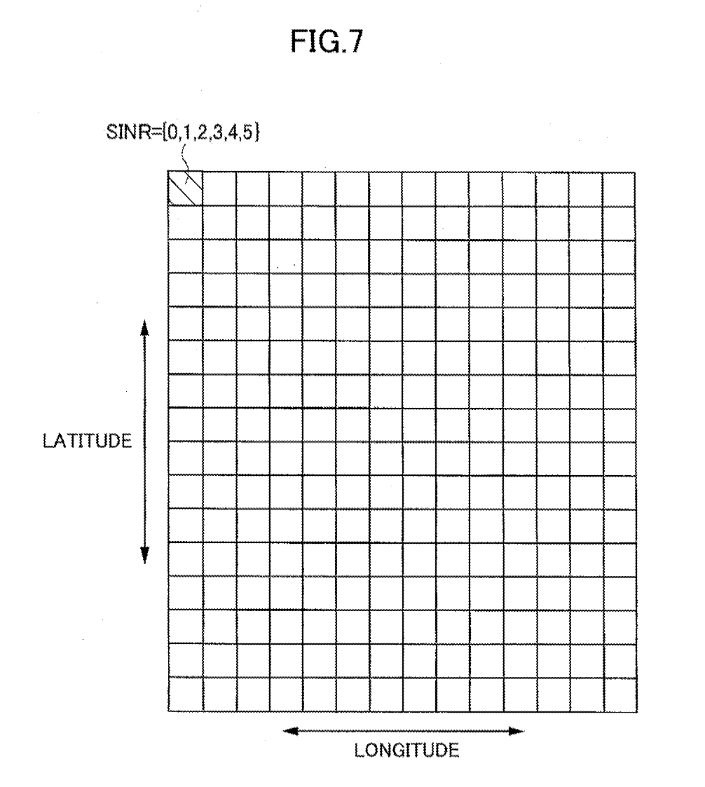

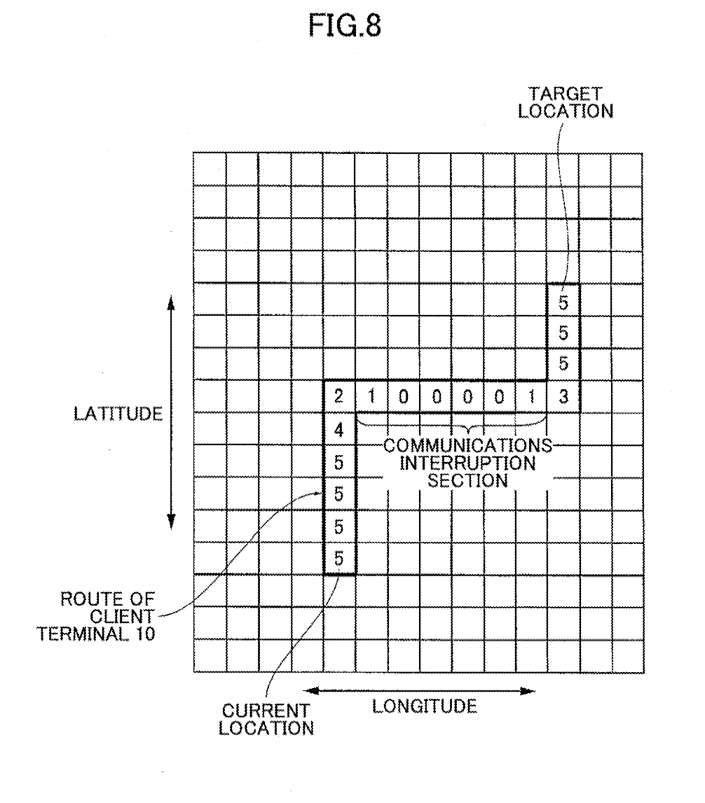

Next, a description is given, with reference to FIG. 3 through FIG. 8, of functional blocks of the client terminal 10 and functional blocks of the server 20. FIG. 3 is a functional block diagram illustrating functions of the client terminal 10 that are basically implemented by the CPU 11. FIG. 4 is a diagram illustrating data stored in the HDD 15 of the client terminal 10. FIG. 5 is a functional block diagram illustrating functions of the server 20 that are basically implemented by the CPU 21. FIG. 6 is a diagram illustrating data stored in the HDD 25 of the server 20. FIG. 7 is a diagram conceptually illustrating communications quality information retained in the HDD 25 by the server 20. FIG. 8 is a diagram conceptually illustrating a correlation between the route of the client terminal 10 and the communications quality information retained by the server 20.

The thin client system of this embodiment provides its service in the following manner when the communication is established between the client terminal 10 and the server 20.

When a user of the client terminal 10 operates the input device 16, for example, a keyboard or a mouse, the input device 16 generates input information, and this input information is transmitted to the server 20. The server 20 retains (contains) a file that is the target of an application. The server 20 has activated and executed the application, and interprets the input information received from the client terminal 10 and executes processing on the file on the application. If the server 20 determines, as a result of the processing on the file, to change the image to be displayed on the client terminal 10, the server 20 transmits the data of the image (image data) to the client terminal 10. The client terminal 10 causes the display device 17 to display an image based on the image data received from the server 20.

The form of service is as described above when the communication between the client terminal 10 and the server 20 is established. According to this embodiment, the thin client system performs the following processing so that when the communication between the client terminal 10 and the server 20 is interrupted (cut off), the service continues during the period of interruption.

The client terminal 10 transmits the route (routing) information of the client terminal 10 to the server 20. The server 20 contains communications quality information 25-2 (FIG. 6) including the quality of communications of predetermined geographical areas on an area basis in the HDD 25. The client terminal 10 sequentially transmits the location information of the client terminal 10 to the server 20. The server 20 sequentially predicts the quality of radio communications with the client terminal 10 on the route indicated by the route information received from the client terminal 10 based on the location information of the client terminal 10 and the communications quality information 25-2. As a result, if an interruption of communications with the client terminal 10 is predicted, the server 20 transmits data (first data) that are at least part of the file that is a target of processing (that is, the file that is being processed) to the client terminal 10 before the communications are interrupted.

During the interruption of communications, the client terminal 10 activates an application, and performs processing on the received first data. Upon restoration of communications, the client terminal 10 transmits second data, into which the first data have been processed during the interruption of communications, to the server 20. The server 20 replaces the first data in the file stored in the server 20 with the received second data. The above-described process allows file processing to continue over a period of the interruption of communications between the client terminal 10 and the server 20 (that is, the file processing is allowed to continue over the period between before and after the interruption of communications between the client terminal 10 and the server 20).

Referring to FIG. 3, the client terminal 10 has a group of functional blocks (a functional block group) 100. The functional block group 100 includes functional blocks such as a file processing part 101, a display processing part 102, a reference file switching part 103, a route calculating part 104, and a transmission data generating part 105. All or some of these functional blocks may be coded as modules of a program executed by the CPU 11.

The file processing part 101 passes input information from the input device 16 to the transmission data generating part 105 without executing an application when the communications are established between the client terminal 10 and the server 20.

When the communications between the client terminal 10 and the server 20 are interrupted, the file processing part 101 stores file data (first data) transmitted from the server 20 before the interruption in the HDD 15 as a local file 15-1 (FIG. 4). Further, during the interruption of communications with the server 20, the file processing part 101 activates an application and performs processing on the local file 15-1 in the HDD 15. If the image to be displayed on the display device 17 is to be changed as a result of the processing on the local file 15-1, the file processing part 101 transmits image data that are the data of the image to the display processing part 102. Upon restoration of communications with the server 20, the file processing part 101 passes second data, which are the results of processing the first data, to the transmission data generating part 105.

The reference file switching part 103, based on switch information received from the server 20, instructs the file processing part 101 to execute a process to be executed when the communications between the client terminal 10 and the server 20 are interrupted. In response to the instruction given by the reference file switching part 103, the file processing part 101 refers to the local file 15-1 in the HDD 15 as a file to be processed.

The display processing part 102 performs display processing for the display device 17, such as displaying an image on the display device 17, based on the image data received from the server 20 via the communications interface 14 when the communications between the client terminal 10 and the server 20 are established. On the other hand, when the communications between the client terminal 10 and the server 20 are interrupted, the display processing part 102 performs display processing for the display device 17, such as displaying an image on the display device 17, based on the image data transmitted from the file processing part 101.

The route calculating part 104 executes a route search program based on the location information sequentially sent from the GPS receiver 18 and generates route information. The route information is information on a route from a current location to a target location on a two-dimensional map using latitude and longitude. For example, the route search program may search for the shortest route from a current location to the target location input to the input device 16 by a user, referring to map data 15-2 (FIG. 4) stored in the HDD 15. The route calculating part 104 passes the generated route information to the transmission data generating part 105.

The transmission data generating part 105 generates transmission data addressed to the server 20, and sends the generated transmission data (to be transmitted) to the communications interface 14. The transmission data include at least one of the input information or file data (second data) sent from the file processing part 101, the route information sent from the route calculating part 104, and the location information sequentially sent from the GPS receiver 18.

Referring to FIG. 5, the server 20 has a group of functional blocks (a functional block group) 200. The functional block group 200 includes functional blocks such as a file processing part 201, an image processing part 202, a communications quality predicting part 203, and a transmission data generating part 204. All or some of these functional blocks may be coded as modules of a program executed by the CPU 21.

The file processing part 201 executes an application and processes a file stored in the HDD 25 based on input information sequentially received from the client terminal 10 when the communications between the client terminal 10 and the server 20 are established. (Hereinafter, the file retained by the server 20 is referred to as a “master file 25-1” [FIG. 6].) The file processing part 201 notifies the image processing part 202 of the result of processing the master file 25-1. In the case of changing the image to be displayed on the client terminal 10 as a result of processing the master file 25-1 by the processing part 201, the image processing part 202 transmits the data of the image (image data) to the transmission data generating part 204.

If an interruption of communications is predicted between the client terminal 10 and the server 20, the file processing part 201 sends data (first data) that are at least part of the master file 25-1 to the transmission data generating part 204 before the interruption. The first data are sent to the communications interface 24 as transmission data (to be transmitted), and are transmitted to the client terminal 10. The file processing part 201 generates the first data in response to switch information received from the communications quality predicting part 203 as a trigger.

The first data are preferably data preceding and data subsequent to a position in the master file 25-1 at which data are being processed (for example, a position in the master file 25-1, detected based on the input information, at which a user is working) when the interruption is predicted, or data in the master file 25-1 subsequent to that position. Further, the amount of data of the first data may be determined as desired. For example, the amount of data of the first data may be specified in advance by a user. Alternatively, the amount of data processible by a user within an average time length of communications interruption may be determined in advance, and the value obtained by adding a margin to the determined amount of data may be determined as the amount of data of the first data. If a file to be processed is, for example, a document file, the first data may be several pages' worth of data preceding and subsequent to a current working position in the file, or the first data may be the data of the whole document file.

The communications quality predicting part 203 predicts the quality of radio communications with the client terminal 10 on the route indicated by the route information received from the client terminal 10 by referring to the communications quality information 25-2 in the HDD 25 using the location information and the route information received from the client terminal 10 as a key.

The communications quality information 25-2 in the HDD 25 includes the radio communications quality of predetermined geographical areas on an area basis. FIG. 7 is a conceptual graphical representation of an example of the communications quality information 25-2. In FIG. 7, by way of example, signal to noise plus interference power ratio (SINR) is indicated on a scale of 0 to 5 as the radio quality information of each area in the case of dividing a geographical scope (defined by particular latitude and longitude) where the client terminal 10 is supposed to move into predetermined areas. That is, the communications quality information 25-2 of the predetermined areas is indicated on an area basis by the six SINR levels of 0 (worst communications environment) to 5 (best communications environment).

Such communications quality information in a particular geographical scope is stored in advance in the HDD 25 of the server 20 as statistical information. For example, if the client terminal 10 is a cellular phone, a base station managed by the telecommunications carrier of the cellular phone is capable of collecting and performing statistical processing on the quality of upstream and downstream communications between the base station and the cellular phone in accordance with the location of the cellular phone. Such statistically processed information may be stored in advance in the HDD 25 of the server 20 as the communications quality information 25-2.

The communications quality predicting part 203 determines whether the communications with the client terminal 10 are to be interrupted in the near future based on the current location of the client terminal 10 by correlating the route indicated by the route information received from the client terminal 10 and the communications quality information 25-2 in the HDD 25.

For example, in the case illustrated in FIG. 8, the route between the current location and the target location of the client terminal 10 based on the route information and the location information transmitted from the client terminal 10, and the area-by-area communications quality information (six SINR levels) of predetermined areas on the route are illustrated. Here, it is assumed that there is a section of a poor radio communications environment (for example, a section whose SINR level is 1 or 0), such as a tunnel, on the route of the client terminal 10. In this case, as illustrated in FIG. 8, the communications quality predicting part 203 determines (specifies) a communications interruption section (where it is predicted that an interruption of communications is to occur) with reference to the current location of the client terminal 10. The communications quality predicting part 203 may determine that the communications between the client terminal 10 and the server 20 are to be interrupted in the near future in response to the distance between the current location and a location at which the communications interruption starts being less than or equal to a predetermined threshold.

In response to determining that the communications between the client terminal 10 and the server 20 are to be interrupted in the near future, the communications quality predicting part 203 generates switch information, and transmits the switch information to the file processing part 201 and the transmission data generating part 204.

The transmission data generating part 204 generates transmission data addressed to the client terminal 10, and sends the generated transmission data (to be transmitted) to the communications interface 24. The transmission data include at least one of the image data sent from the image processing part 202, the file data (first data) sent from the file processing part 201, and the switch information sent from the communications quality predicting part 203.

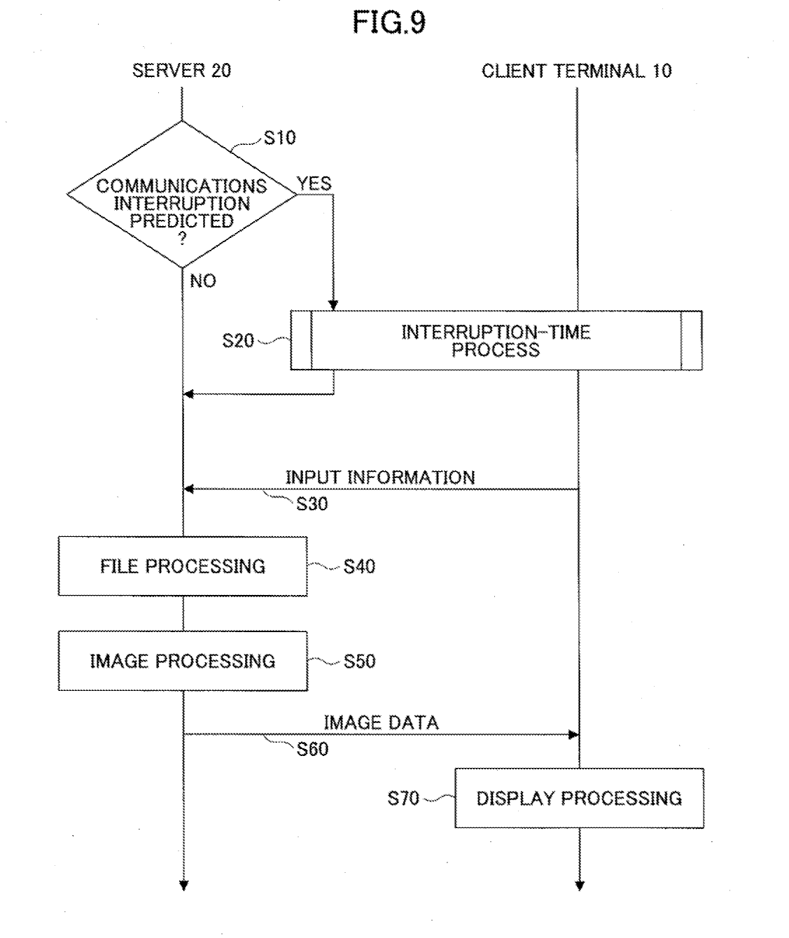

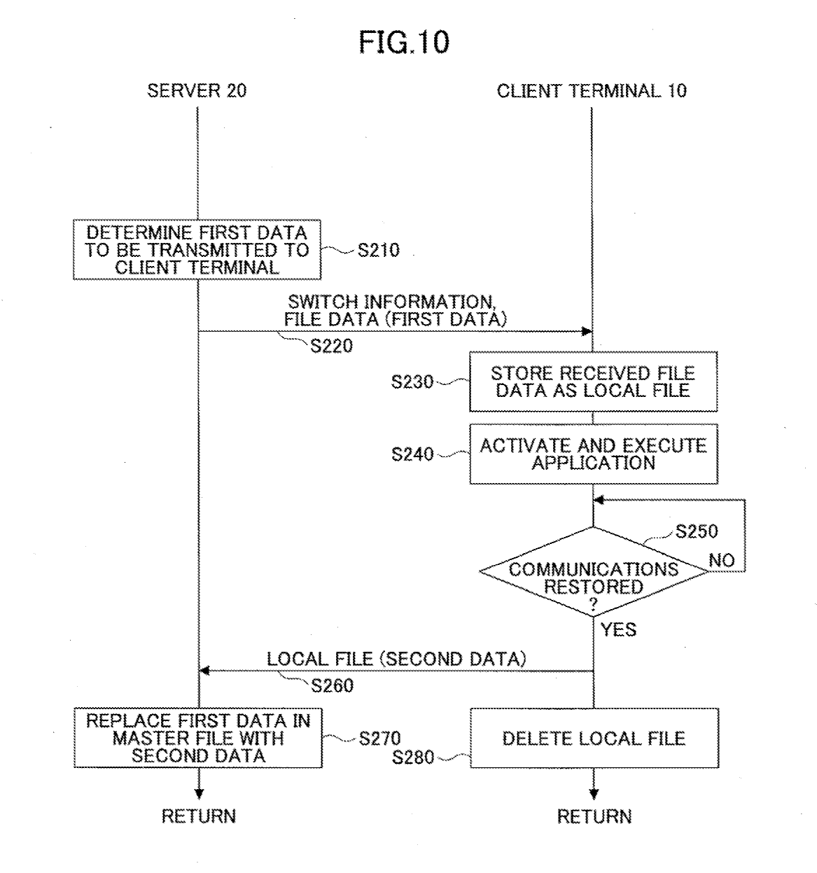

Next, a description is given, with reference to FIG. 9 and FIG. 10, of a process flow of the client terminal 10 and the server 20 according to this embodiment. FIG. 9 is a flowchart illustrating an overall process flow of the client terminal 10 and the server 20. FIG. 10 is a flowchart illustrating a process at the time when the communications between the client terminal 10 and the server 20 are interrupted.

It is assumed that the communications between the client terminal 10 and the server 20 are established at the beginning of the flow of FIG. 9. At this point, in step S10, the server 20 determines whether an interruption of communications between the client terminal 10 and the server 20 is predicted (that is, whether the communications between the client terminal 10 and the server 20 are to be interrupted in the near future). At this point, in the server 20, the communications quality predicting part 203 estimates the quality of radio communications with the client terminal 10 on the route indicated by the route information received from the client terminal 10 by referring to the communications quality information 25-2 in the HDD 25 using the location information and the route information received from the client terminal 10 as a key. As a result, if the server 20 determines that the communications between the client terminal 10 and the server 20 are to be interrupted in the near future (YES in step S10), in step S20, the server 20 executes a process that is to be executed when the communications between the client terminal 10 and the server 20 are interrupted. The details of this interruption-time process are illustrated in FIG. 10.

If the communications environment between the client terminal 10 and the server 20 continues to be good (NO in step S10), step S10 is followed by the process of step S30 and the subsequent steps.

In step S30, in response to an operation of the input device 16 of the client terminal 10, for example, a keyboard or a mouse, by a user of the client terminal 10, the input device 16 generates input information, and the input information is transmitted from the client terminal 10 to the server 20. In step S40, in response to receiving the input information from the client terminal 10, the server 20 executes an application and processes the master file 25-1 (FIG. 6) stored in the HDD 25. In step S50, the server 20 performs image processing. If the image to be displayed in the client terminal 10 is to be changed as a result of the image processing, in step S60, the server 20 transmits image data to the client terminal 10. The server 20 executes the process of steps S40 through S60 in the following manner.

That is, the file processing part 201 executes an application and processes the master file 25-1 stored in the HDD 25. The file processing part 201 reports the result of processing the master file 25-1 to the image processing part 202. The image processing part 202 sends image data to the transmission data generating part 204. The transmission data generating part 204 sends the image data as transmission data to the communications interface 24.

Upon reception of the image data from the server 20, the client terminal 10 displays an image on the display device 17 based on the image data.

As described above, while the communications environment between the client terminal 10 and the server 20 continues to be good, the input information is transmitted from the client terminal 10 to the server 20, and the image data are transmitted from the server 20 to the client terminal 10. Thereby, a thin client service related to file processing is provided from the server 20 to the client terminal 10. If the communications environment between the client terminal 10 and the server 20 continues to be good, the file to be processed (the target of processing) is the master file 25-1 in the server 20.

On the other hand, the details of the interruption-time process (step S20 of FIG. 9) are as illustrated in FIG. 10. If the communications quality predicting part 203 of the server 20 determines in step S10 of FIG. 9 that the communications between the client terminal 10 and the server 20 are to be interrupted in the near future (YES in step S10), the communications quality predicting part 203 transmits switch information to the file processing part 201. In step S210 of FIG. 10, in response to reception of the switch information as a trigger, the file processing part 201 determines the first data to be transmitted to the client terminal 10. The first data may be, for example, several pages' worth of data preceding and subsequent to a position in the master file 25-1 at which data are being processed at the time of the determination of step S10 of FIG. 9 (that is, a current working position in the master file 25-1), or the first data may be the data of the whole document file.

Next, in step S220, the server 20 transmits the switch information and the first data (file data) to the client terminal 10. In step S230, in the client terminal 10, in response to reception of the switch information, the reference file switching part 103 instructs the file processing part 101 to execute a process to be executed when the communications between the client terminal 10 and the server 20 are interrupted. Further, the file processing part 101 stores the first data transmitted from the server 20 in the HDD 15 as the local file 15-1 (FIG. 4). In step S240, based on the instruction given by the reference file switching part 103, the file processing part 101 activates and executes an application. The file processing part 101 performs file processing, referring to the local file 15-1 stored in the HDD 15.

Thereafter, in step S250, it is determined whether the communications with the server 20 have been restored. If it is determined in step S250 that the communications with the server 20 have been restored (YES in step S250), in step S260, the client terminal 10 transmits the data of the local file 15-1 processed during the interruption of communications (that is, the second data) to the server 20.

In response to reception of the data of the local file 15-1 (second data) from the client terminal 10, the server 20 replaces the first data in the master file 25-1 with the received data of the local file 15-1 (second data). That is, the file processing part 201 of the server 20 replaces the first data (the file data transmitted in step S220) in the master file 25-1 stored in the server 20 with the received second data. As a result, the file processing executed in the client terminal 10 during the period of the interruption of communications between the client terminal 10 and the server 20 is reflected in the master file 25-1. Preferably, in step S280, the client terminal 10 deletes the local file 15-1 in the HDD 15 after step S260 in light of security.

Upon completion of the interruption-time process, the process of step S30 and the subsequent steps in FIG. 9 (that is, the process executed when the communications between the client terminal 10 and the server 20 are established) is executed.

As described above, according to the thin client system of this embodiment, when an interruption of communications is predicted between the client terminal 10 and the server 20, data in a file in the server 20 (first data) are transmitted in advance to the client terminal 10. During the interruption of communications, the client terminal 10 performs file processing, referring to the first data. When the communications are restored, the client terminal 10 transmits second data, which are the processed first data, to the server 20, and the server 20 replaces the first data with the received second data. This makes it possible to continue file processing over the interruption of communications between the client terminal 10 and the server 20.

### [b] Second Embodiment

A description is given below of a second embodiment.

In light of efficient use of communications resources, it is preferable that the amount of data of the file data (first data) transmitted from the server 20 to the client terminal 10 when an interruption of communications is predicted between the client terminal 10 and the server 20 be smaller. On the other hand, if the amount of data of the first data is excessively small, the client terminal 10 may be prevented from executing file processing as desired by a user during the period of communications interruption, thus causing a practical problem. Therefore, according to the second embodiment, the amount of data of the first data is so calculated as to cause no problems in file processing in the client terminal 10 and to enable efficient use of communications resources during a communications interruption period.

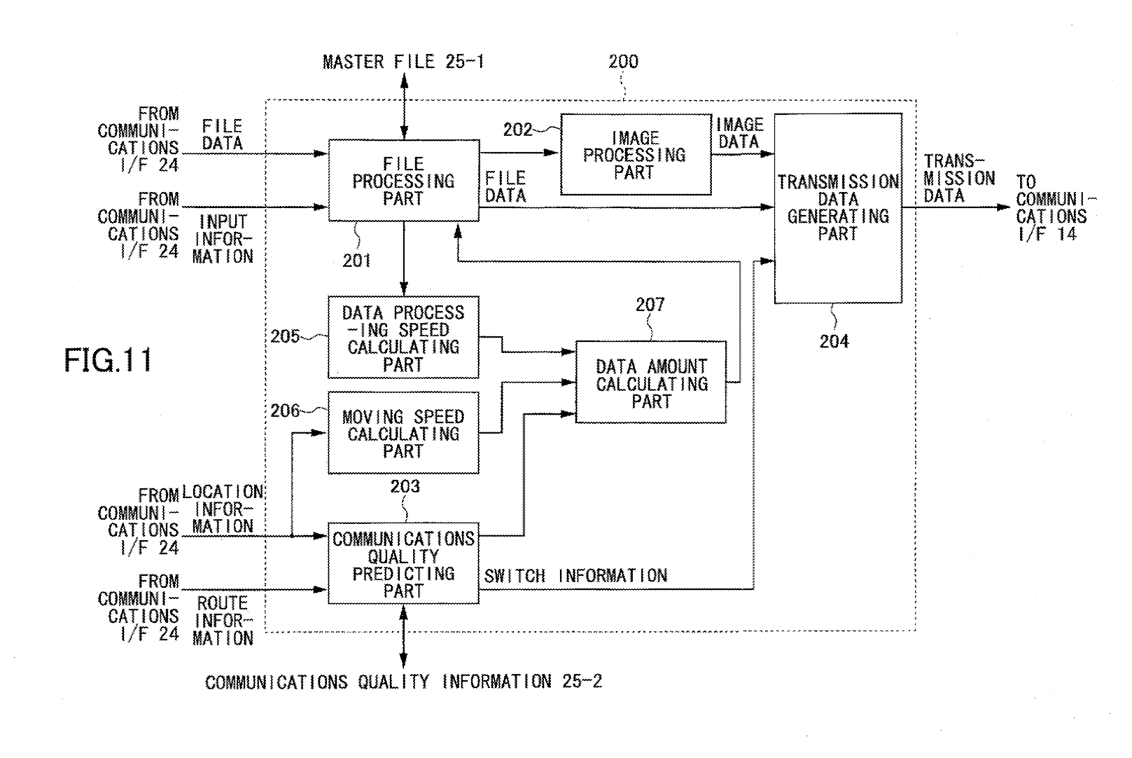

First, a description is given, with reference to FIG. 11, of functional blocks of the server 20 according to this embodiment. FIG. 11 is a functional block diagram illustrating functions of the server 20 that are basically implemented by the CPU 21. Compared with the functional block diagram of FIG. 5, the functional block group 200 of the server 20 illustrated in FIG. 11 is different from the functional block group 200 illustrated in FIG. 5 in additionally including a data processing speed calculating part 205, a moving (traveling) speed calculating part 206, and a data amount calculating part 207. In a thin client system according to this embodiment, the functional block diagram of the client terminal 10 may be the same as illustrated in FIG. 3.

The data processing speed calculating part 205 calculates a data processing speed by measuring the amount of data of the master file 25-1 (FIG. 6) processed in the file processing part 201 per unit time when the communications between the client terminal 10 and the server 20 are established. The data processing speed differs from client terminal 10 to client terminal 10. Accordingly, the data processing speed is calculated on a client terminal 10 basis. The timing of calculating the data processing speed may be arbitrarily determined. The data processing speed calculating part 205 sends the calculated data processing speed to the data amount calculating part 207.

The moving speed calculating part 206 calculates the moving speed of the client terminal 10 based on the location information sequentially transmitted from the client terminal 10. At least two pieces of location information received at different points of time make it possible to calculate the moving speed. Since the moving speed of the client terminal 10 may vary sequentially, the moving speed calculating part 206 calculates the moving speed of the client terminal 10 at predetermined time intervals, and transmits the calculated moving speed to the data amount calculating part 207 each time.

The communications quality predicting part 203 specifies a section where the communications are to be interrupted (the communications interruption section illustrated in FIG. 8) on the route indicated by the route information received from the client terminal 10, referring to the communications quality information 25-2 (FIG. 6) in the HDD 25, and sends information on this specified communications interruption section to the data amount calculating part 207. The communications quality predicting part 203 sends the information on the communications interruption section to the data amount calculating part 207 when (in response to) determining that the communications with the client terminal 10 are to be interrupted in the near future.

The data amount calculating part 207 calculates the amount of data of the file data (first data) to be transmitted from the file processing part 201 to the transmission data generating part 204 based on the data processing speed, the moving speed of the client terminal 10, and the communications interruption section. This data amount calculation, which is performed when the communications with the client terminal 10 are to be interrupted in the near future, may be triggered by the reception of the information on the communications interruption section from the communications quality predicting part 203.

Here, letting the data processing speed, the moving speed of the client terminal 10, and the distance of the communications interruption section be SDT, SCL, and L, respectively, the amount of data D (estimated value) that may be processed in the client terminal 10 during the interruption of communications may be determined by:

D=(L/SCL)×SDT. (1)

The data amount calculating part 207 may determine, as the amount of data of the first data, the value obtained by adding a margin of a predetermined amount to the amount of data D determined by Eq. (1). The data amount calculating part 207 notifies the file processing part 201 of the calculated amount of data of the first data.

According to this embodiment, the file processing part 207 generates the first data in response to being notified of the amount of data by the data amount calculating part 207 as a trigger. The first data generated by the file processing part 201 may be data preceding and data subsequent to a position in the master file 25-1 at which data are being processed (for example, a position in the master file 25-1, detected based on the input information, at which a user is working) or be data in the master file 25-1 subsequent to that position. The amount of data of the first data is the same as the amount of data reported to the file processing part 201 by the data amount calculating part 207.

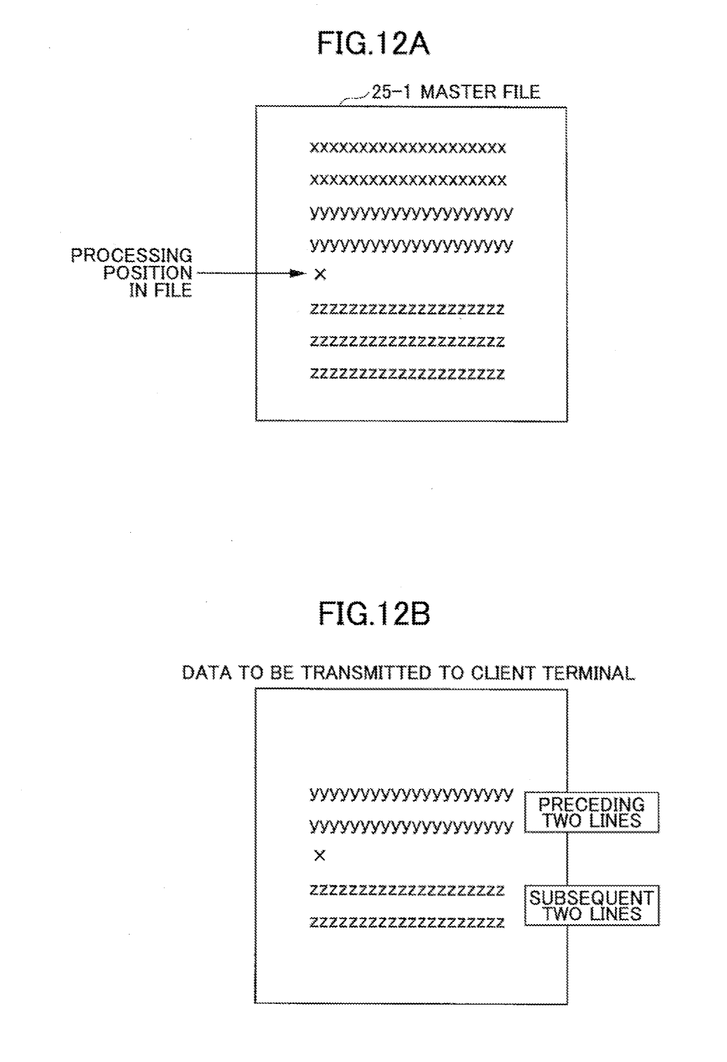

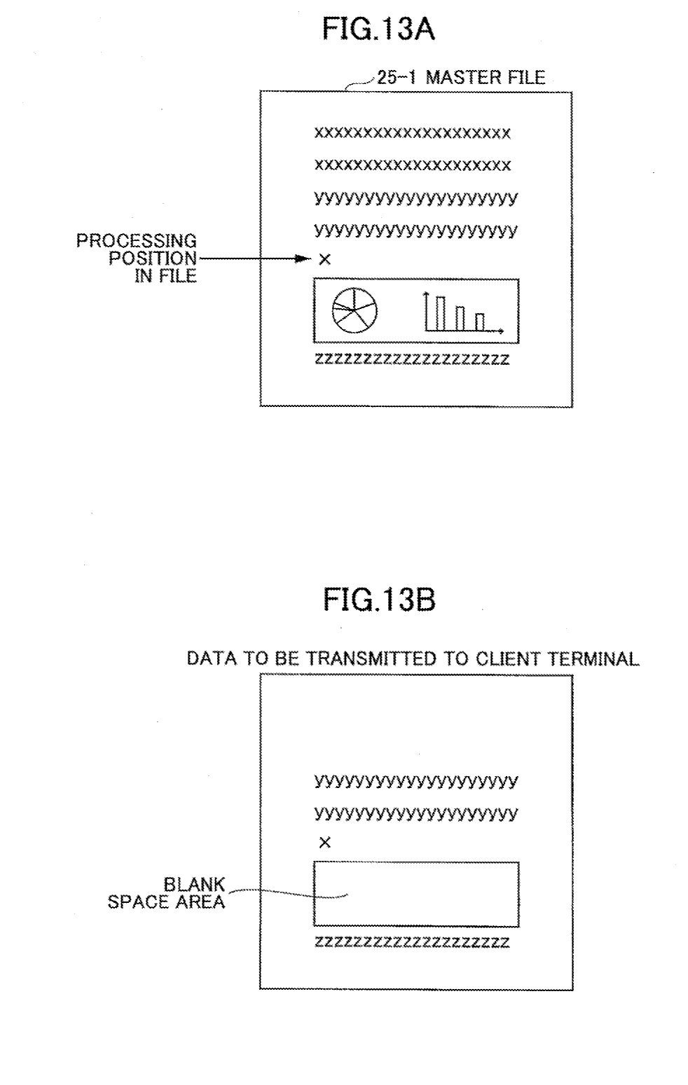

FIGS. 12A and 12B and FIGS. 13A and 13B are diagrams illustrating examples of the master file 25-1 and the first data in the master file 25-1 that the server 20 transmits to the client terminal 10. FIG. 12A and FIG. 13A illustrate examples of the master file 25-1 and FIG. 12B and FIG. 13B illustrate examples of the first data (file data) to be transmitted to the client terminal 10.

FIGS. 12A and 12B assume a case where a file to be processed (the master file 25-1) is document data formed of text. In FIGS. 12A and 12B, a position in the master file 25-1 at which data are being processed when a trigger for the file processing part 201 to transmit the first data is generated is indicated by a cross mark (x). In this case, as illustrated in FIG. 12B, the data of the two lines preceding and the two line subsequent to the cross mark may be the first data in accordance with the amount of data reported from the data amount calculating part 207.

On the other hand, FIG. 13A and FIG. 13B assume a case where an image is included in the master file 25-1 (document data). In this case, if the image is not an object of processing on the client terminal 10 side, it is preferable to exclude the image from the first data (for example, to leave the area of the image blank in the first data). Exclusion of the image from the first data makes it possible to substantially increase the amount of data (for example, text data) to be processed in the client terminal 10.

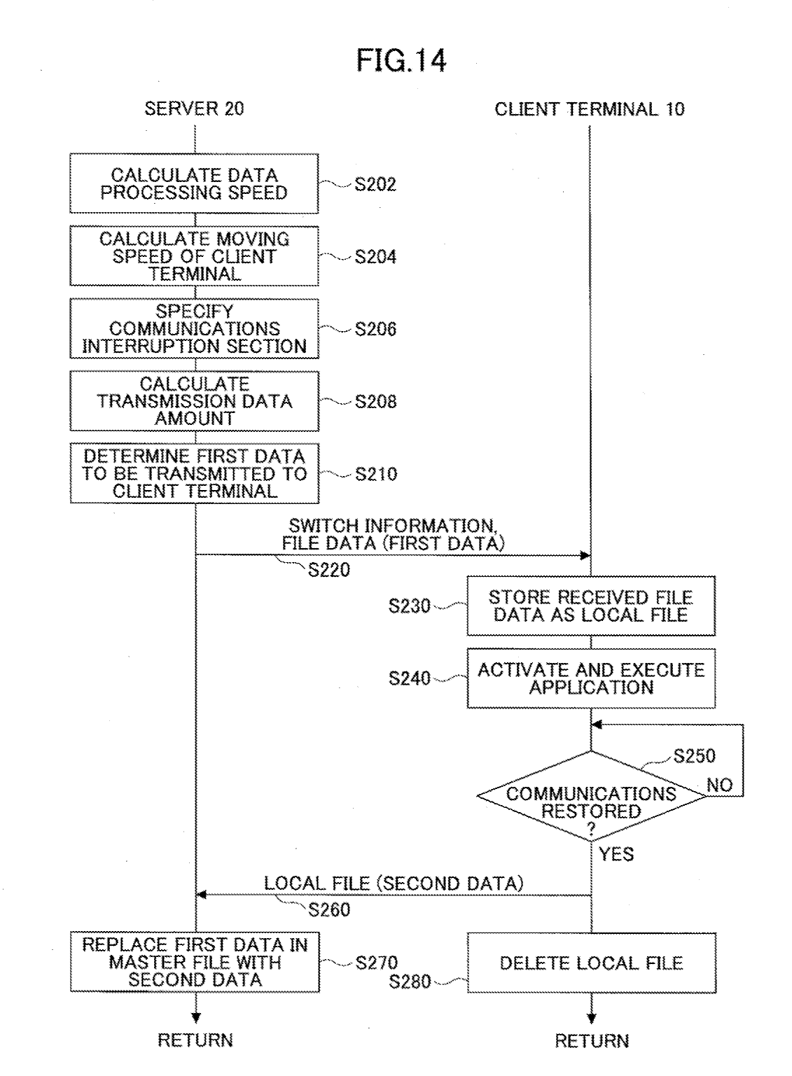

Next, a description is given, with reference to FIG. 14, of a process flow of the client terminal 10 and the server 20 according to this embodiment. FIG. 14 is a flowchart illustrating a process at the time when the communications between the client terminal 10 and the server 20 are interrupted. The overall process flow of the client terminal 10 and the server 20 according to this embodiment may be the same as the process flow illustrated in FIG. 9.

Compared with FIG. 10, the process flow of FIG. 14 is different from the process flow of FIG. 10 in the process preceding step S220 (that is, steps S202, S204, S206, S208, and S210).

In the server 20, steps S202, S204, S206, and S208 are successively performed if the communications quality predicting part 203 determines that the communications between the client terminal 10 and the server 20 are to be interrupted in the near future. Specifically, for example, in step S202, the data processing speed calculating part 205 calculates a data processing speed by measuring the amount of data of the master file 25-1 processed per unit time in the file processing part 201. Next, in step S204, the moving speed calculating part 206 calculates the moving speed of the client terminal 10 based on the location information sequentially transmitted from the client terminal 10. Further, in step S206, the communications quality predicting part 203 specifies a communications interruption section on the route indicated by the route information received from the client terminal 10, referring to the communications quality information 25-2 in the HDD 25. In step S208, the data amount calculating part 207 calculates the amount of data of the first data to be transmitted to the client terminal 10 based on the calculated data processing speed, the calculated moving speed of the client terminal 10, and the specified communications interruption section. In step S210, the file processing part 201 determines the first data in the master file 25-1 based on the amount of data calculated in step S208. The first data may be data preceding and data subsequent to a position in the master file 25-1 at which data are being processed.

As described above, according to the thin client system of this embodiment, the amount of data that may be processed in the client terminal 10 when the communications with the client terminal 10 are interrupted is determined in view of the moving speed of the client terminal 10, the data processing speed, and the length of the communications interruption section. Therefore, the file data (first data) transmitted from the server 20 to the client terminal 10 before the interruption of communications may be such data as to cause no problems in file processing in the client terminal 10 and to enable efficient use of communications resources during a communications interruption period.

All examples and conditional language recited herein are intended for pedagogical purposes to aid the reader in understanding the invention and the concepts contributed by the inventors to furthering the art, and are to be construed as being without limitation to such specifically recited examples and conditions, nor does the organization of such examples in the specification relate to a showing of the superiority or inferiority of the invention. Although the embodiments of the present invention have been described in detail, it should be understood that various changes, substitutions, and alterations could be made hereto without departing from the spirit and scope of the invention.

What is claimed is:

1. A server, comprising:
a storage configured to store communications quality information including communications quality of predetermined geographical areas on an area basis;
a receiver configured to receive information input to a client terminal, location information of the client terminal, and route information of the client terminal from the client terminal via a radio communication;
a processor configured to process a file based on the input information, and to predict quality of the radio communication with the client terminal on a route indicated by the route information of the client terminal based on the location information of the client terminal and the communications quality information; and
a transmitter configured to transmit an image to be displayed on the client terminal to the client terminal via the radio communication based on a result of processing the file by the processor,
wherein the processor is configured to transmit first data to the client terminal if an interruption of the radio communication with the client terminal is predicted, the first data being at least a part of the file, and to receive second data from the client terminal after the radio communication with the client terminal is restored and to replace the first data with the received second data, the second data being the first data processed by the client terminal during the interruption of the radio communication.

2. The server as claimed in claim 1, wherein the processor is configured to specify a section where the radio communication with the client terminal is to be interrupted on the route based on the communications quality on the route; to calculate a data processing speed indicating an amount of data of the file processed per unit time by the processor; to calculate a moving speed of the client terminal based on at least two pieces of the location information received at different points of time; to calculate an estimated value of an amount of data to be processed during the interruption of the radio communication with the client terminal, based on a distance of the section, the data processing speed, and the moving speed; and to determine an amount of data of the first data from the estimated value.

3. A client terminal, comprising:
a receiver configured to receive first data from a server, the first data being at least a part of a file stored in the server;
a file processor configured to process the first data during an interruption of a radio communication with the server; and
a transmitter configured to transmit second data to the server after the radio communication with the server is restored, the second data being the first data processed by the file processor during the interruption of the radio communication,
wherein the file processor is configured to delete at least one of the first data and the second data from the client terminal after the radio communication with the server is restored.

4. The client terminal as claimed in claim 3, wherein:
the receiver is configured to receive an instruction to process the first data in the client terminal from the server, and
the file processor is configured to process the first data by activating and executing an application in response to receiving the instruction from the server.

5. The client terminal as claimed in claim 3, wherein the file processor is configured to generate an image to be displayed based on a result of processing the first data during the interruption of the radio communication.

6. An information processing method, comprising:
transmitting, by a client terminal, information input to the client terminal, location information of the client terminal, and route information of the client terminal to a server via a radio communication;
processing, by the server, a file based on the input information, and transmitting, by the server, an image to be displayed on the client terminal to the client terminal via the radio communication based on a result of said processing;
referring to, by the server, communications quality information including communications quality of predetermined geographical areas on an area basis, and predicting, by the server, quality of the radio communication with the client terminal on a route indicated by the route information of the client terminal based on the location information of the client terminal and the communications quality information;
transmitting, by the server, first data to the client terminal if an interruption of the radio communication with the client terminal is predicted, the first data being at least a part of the file;
transmitting, by the client terminal, second data to the server after the radio communication with the server is restored, the second data being the first data processed by the client terminal during the interruption of the radio communication; and
replacing, by the server, the first data with the second data received from the client terminal.

7. The information processing method as claimed in claim 6, further comprising:
specifying, by the server, a section where the radio communication with the client terminal is to be interrupted on the route based on the communications quality on the route;
calculating, by the server, a data processing speed indicating an amount of data of the file processed per unit time;
calculating, by the server, a moving speed of the client terminal based on at least two pieces of the location information received at different points of time;
calculating, by the server, an estimated value of an amount of data to be processed during the interruption of the radio communication with the client terminal, based on a distance of the section, the data processing speed, and the moving speed; and
determining, by the server, an amount of data of the first data from the estimated value.
